(19) United States
(12) Patent Application Publication
(10) Pub. No.: US 2004/0132328 A1
(43) Pub. Date: Jul. 8, 2004

(54) Replaceable plug module

(76) Inventor: Wen-Ko Wu, Taipei (TW)

Correspondence Address: Charles E. Baxley, Hart, Baxley, Daniels & Holton, Fifth Floor, 59 John Street, New York, NY, 10038, US

(21) Appl. No.: 10/336,970

(22) Filed: Jan. 6, 2003

(51) Int. Cl. H01R 29/00

(52) U.S. Cl. 439/172

(57) ABSTRACT

A replaceable plug module includes a plug seat, and a plug. The plug seat has a side face formed with a locking recess formed with a first catch plate and a second catch plate. The plug is provided with a first snapping portion combined with and rotatably mounted on the first catch plate of the plug seat and a second snapping portion combined with the second catch plate of the plug seat. Thus, the replaceable plug module can replace different plugs of different kinds and sizes, thereby enhancing the versatility of replaceable plug module.

### BACKGROUND OF THE INVENTION

1. Field of the Invention

The present invention relates to a replaceable plug module, and more particularly to a replaceable plug module that can replace different plugs of different kinds and sizes, thereby enhancing the versatility of replaceable plug module.

2. Description of the Related Art

An electric appliance usually includes a plug that is inserted into a socket so as to connect the electric power. However, the conventional plug has a fixed size, so that the conventional plug is only available for the socket of a fixed size, and cannot be available for sockets of different kinds and sizes, thereby decreasing the versatility of the plug. Thus, the user has to replace the plug so as to fit sockets of different kinds and sizes.

### SUMMARY OF THE INVENTION

The present invention has arisen to mitigate and/or obviate the disadvantage of the conventional plug.

The primary objective of the present invention is to provide a replaceable plug module that can replace different plugs of different kinds and sizes, thereby enhancing the versatility of replaceable plug module.

Another objective of the present invention is to provide a replaceable plug module, wherein the plug is mounted on or detached from the plug seat easily and conveniently by rotation of the plug, so that the plug can be replaced rapidly and exactly.

A further objective of the present invention is to provide a replaceable plug module, wherein the plug is secured on the plug seat by the locking action of the snap hook of the first catch plate and the snap hook of the second catch plate of the plug seat, so that the plug is exactly combined with the plug seat rigidly and stably.

In accordance with the present invention, there is provided a replaceable plug module, comprising a plug seat, and a plug, wherein:

the plug seat has a side face formed with a locking recess, the locking recess of the plug seat has a wall formed with a flexible first catch plate and a flexible second catch plate located opposite to the first catch plate; and

the plug is secured in the locking recess of the plug and is provided with a first snapping portion and a second snapping portion located opposite to the first snapping portion, the first snapping portion of the plug is combined with and rotatably mounted on the first catch plate of the plug seat, and the second snapping portion of the plug is combined with the second catch plate of the plug seat.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a replaceable plug module in accordance with a preferred embodiment of the present invention;

FIG. 1A is a perspective view of a plug of the replaceable plug module in accordance with the preferred embodiment of the present invention;

FIG. 2 is a perspective view of another plug of the replaceable plug module in accordance with the preferred embodiment of the present invention;

FIG. 3 is a partially side plan cross-sectional assembly operation view of the replaceable plug module as shown in FIG. 1;

FIG. 4 is a schematic operational view of the replaceable plug module as shown in FIG. 3 in assembly; and

FIG. 5 is a partially side plan cross-sectional assembly view of a replaceable plug module in accordance with another embodiment of the present invention.

### DETAILED DESCRIPTION OF THE INVENTION

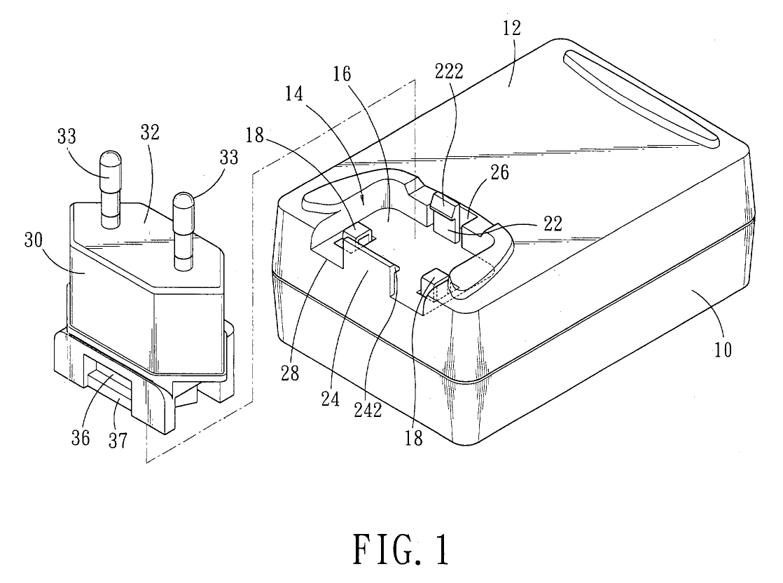

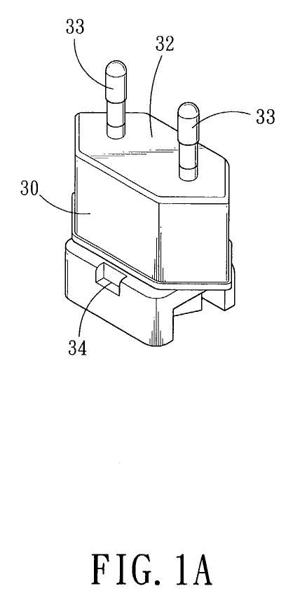

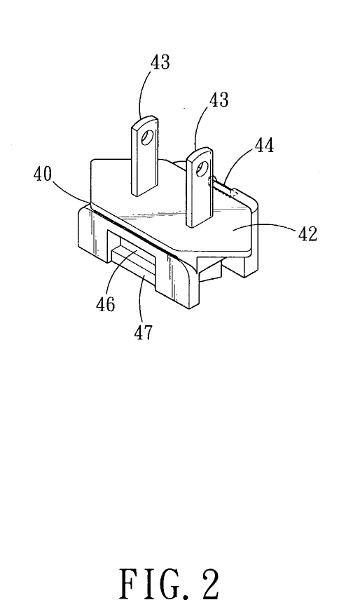

Referring to the drawings and initially to FIGS. 1-3, a replaceable plug module in accordance with a preferred embodiment of the present invention comprises a plug seat 10, and a plug 30 (see FIG. 1) or a plug 40 (see FIG. 2).

The plug seat 10 has a side face 12 formed with a locking recess 14. The locking recess 14 of the plug seat 10 has a bottom face 16 formed with two elastic connectors 18. Each of the two elastic connectors 18 has a first end connected to a conductive connection (not shown) mounted in the plug seat 10 and a second end protruding outward from the bottom face 16 of the locking recess 14 of the plug seat 10.

The locking recess 14 of the plug seat 10 has a wall formed with a flexible first catch plate 22 and a flexible second catch plate 24 located opposite to the first catch plate 22. The first catch plate 22 protrudes outward from the bottom face 16 of the locking recess 14 of the plug seat 10. A gap 26 is formed between the first catch plate 22 and the wall of the locking recess 14 of the plug seat 10, so that the first catch plate 22 has an elastic capability. The first catch plate 22 has an end portion formed with a snap hook 222. The second catch plate 24 is mounted in an opening 28 formed in a side of the wall of the locking recess 14 of the plug seat 10. The second catch plate 24 has an end portion formed with a snap hook 242.

As shown in FIGS. 1 and 1A, the plug 30 has a first end having an end face 32 provided with two spaced protruding insertion posts 33 and a second end provided with a first snapping portion 34 and a second snapping portion 36 located opposite to the first snapping portion 34. In the embodiment of the present invention, the first snapping portion 34 is formed with a recessed structure and the second snapping portion 36 is formed with a recessed structure. In addition, the second snapping portion 36 has a side formed with a shaft portion 37.

As shown in FIG. 2, the plug 40 has a first end having an end face 42 provided with two spaced protruding insertion posts 44 and a second end provided with a first snapping portion 44 and a second snapping portion 46 located opposite to the first snapping portion 44. In the embodiment of the present invention, the first snapping portion 44 is formed with a recessed structure and the second snapping portion 46 is formed with a recessed structure. In addition, the second snapping portion 46 has a side formed with a shaft portion 47.

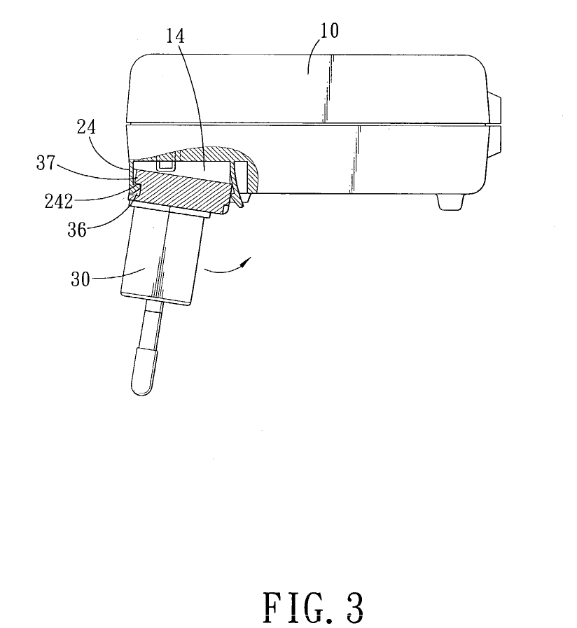

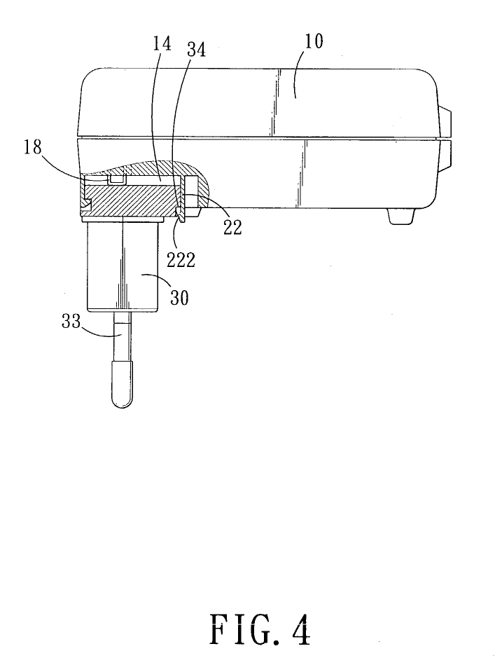

In assembly, referring to FIGS. 3 and 4 with reference to FIGS. 1 and 1A, the second snapping portion 36 of the plug 30 is combined with the second catch plate 24 of the plug seat 10, so that the snap hook 242 of the second catch plate 24 of the plug seat 10 is hooked on the shaft portion 37 of the second snapping portion 36 of the plug 30 as shown in FIG. 3. In such a manner, the snap hook 242 of the second catch plate 24 of the plug seat 10 co-operates with the shaft portion 37 of the second snapping portion 36 of the plug 30 to function as a rotation fulcrum. Thus, the plug 30 can be rotated, so that the plug 30 is inserted into the locking recess 14 of the plug seat 10.

As shown in FIG. 4, when the plug 30 is wholly inserted into the locking recess 14 of the plug seat 10, the snap hook 222 of the first catch plate 22 of the plug seat 10 is snapped and locked on the first snapping portion 34 of the plug 30, so that the plug 30 is entirely combined with the plug seat 10 rigidly and stably. At this time, each of the two insertion posts 33 of the plug 30 is electrically connected to a respective one of the two elastic connectors 18 of the plug seat 10.

In replacement of the plug 30, the user can drive and pull the first catch plate 22 of the plug seat 10 outward, thereby detaching the snap hook 222 of the first catch plate 22 of the plug seat 10 from the first snapping portion 34 of the plug 30. At this time, the plug 30 is pushed by the restoring force of the two elastic connectors 18 of the plug seat 10 to partially detach from the locking recess 14 of the plug seat 10. In such a manner, the snap hook 242 of the second catch plate 24 of the plug seat 10 co-operates with the shaft portion 37 of the second snapping portion 36 of the plug 30 to function as a rotation fulcrum. Thus, the plug 30 can be rotated, so that the plug 30 is detached from the locking recess 14 of the plug seat 10 for replacing another plug.

Accordingly, the plug 30 is mounted on or detached from the plug seat 10 easily and conveniently by rotation of the plug 30, so that the plug can be replaced rapidly and exactly. In addition, the plug 30 is secured on the plug seat 10 by the locking action of the snap hook 222 of the first catch plate 22 and the snap hook 242 of the second catch plate 24 of the plug seat 10, so that the plug 30 is exactly combined with the plug seat 10 rigidly and stably.

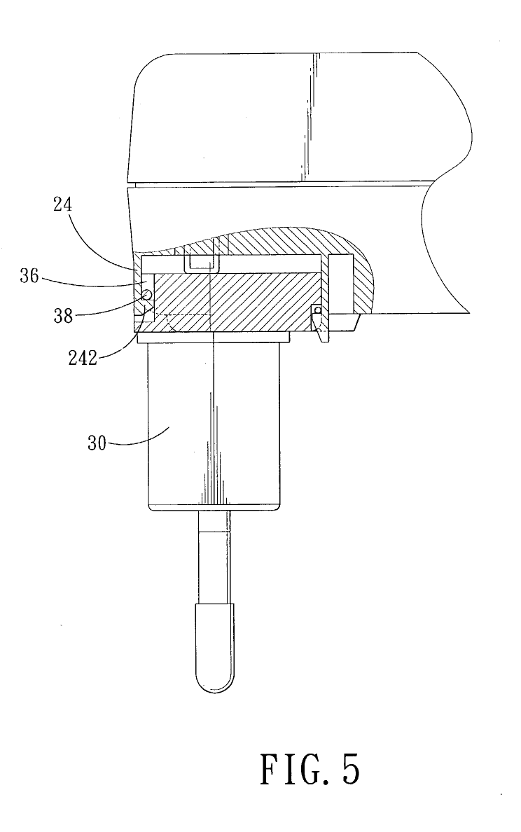

Referring to FIG. 5, a replaceable plug module in accordance with another embodiment of the present invention is shown, wherein the second snapping portion 36 of the plug 30 is provided with a shaft 38 combined with the snap hook 242 of the second catch plate 24 of the plug seat 10.

While the preferred embodiment(s) of the present invention has been shown and described, it will be apparent to those skilled in the art that various modifications may be made in the embodiment(s) without departing from the spirit of the present invention. Such modifications are all within the scope of the present invention.

What is claimed is:

1. A replaceable plug module, comprising a plug seat, and a plug, wherein:
the plug seat has a side face formed with a locking recess, the locking recess of the plug seat has a wall formed with a flexible first catch plate and a flexible second catch plate located opposite to the first catch plate; and
the plug is secured in the locking recess of the plug and is provided with a first snapping portion and a second snapping portion located opposite to the first snapping portion, the first snapping portion of the plug is combined with and rotatably mounted on the first catch plate of the plug seat, and the second snapping portion of the plug is combined with the second catch plate of the plug seat.

2. The replaceable plug module in accordance with claim 1, wherein the first catch plate protrudes outward from the bottom face of the locking recess of the plug seat.

3. The replaceable plug module in accordance with claim 1, wherein a gap is formed between the first catch plate and the wall of the locking recess of the plug seat, so that the first catch plate has an elastic capability.

4. The replaceable plug module in accordance with claim 1, wherein the first catch plate has an end portion formed with a snap hook.

5. The replaceable plug module in accordance with claim 1, wherein the second catch plate is mounted in an opening formed in a side of the wall of the locking recess of the plug seat.

6. The replaceable plug module in accordance with claim 1, wherein the second catch plate has an end portion formed with a snap hook.

7. The replaceable plug module in accordance with claim 1, wherein the bottom face of the locking recess of the plug seat is formed with two elastic connectors protruding outward from the bottom face.

8. The replaceable plug module in accordance with claim 1, wherein the plug has a first end having an end face provided with two spaced protruding insertion posts.

9. The replaceable plug module in accordance with claim 1, wherein the first snapping portion is a recess.

10. The replaceable plug module in accordance with claim 1, wherein the second snapping portion is a recess.

11. The replaceable plug module in accordance with claim 1, wherein the second snapping portion has a side formed with a shaft portion.

12. The replaceable plug module in accordance with claim 1, wherein the second snapping portion has a side formed with a shaft.
